(19) United States
(12) Patent Application Publication
(10) Pub. No.: US 2015/0354185 A1
(43) Pub. Date: Dec. 10, 2015

(54) Pull-out faucet

(71) Applicant: Globe Union Industrial Corp., Taichung City (TW)

(72) Inventors: Kuoming Tseng, Taichung City (TW); Hsiantsung Chen, Taichung City (TW)

(21) Appl. No.: 14/720,794

(22) Filed: May 24, 2015

(30) Foreign Application Priority Data
Jun. 6, 2014 (CN) 201410249258.5

(51) Int. Cl. E03C 1/04; F21V 23/04; F21K 99/00; F21V 33/00; F21V 23/00

(52) U.S. Cl. CPC E03C 1/0404; F21V 33/004; F21V 23/002; F21K 9/52; F21V 23/04; F21V 23/009; E03C 2001/0417; F21Y 2101/02

(57) ABSTRACT

A pull-out faucet contains: a body and a shower assembly mounted on the body. The shower assembly includes a flexible pipe, an inflow member connected with an inlet segment of the flexible pipe, a spray head coupled with an outlet segment of the flexible pipe and retracted back to an outlet of the body after being pulled outwardly, a plurality of LED elements, a circuit board electrically, and an electric wire. The electric wire is inserted into the flexible pipe along a tunnel. The spray head includes a light conductor, a conduit member, an internal sleeve, and an external sleeve. A first stopper has a first orifice to extend out of the electric wire from the outlet segment of the flexible pipe to electrically connect with the circuit board. A second stopper has a second orifice to insert the electric wire from the inlet segment of the flexible pipe.

### FIELD OF THE INVENTION

The present invention relates to a faucet, and more particularly to a pull-out faucet which contains a shower assembly to illuminate lights.

### BACKGROUND OF THE INVENTION

A conventional pull-out faucet contains a shower head for flowing or spraying water, but the shower head cannot illuminate lights.

A conventional illuminative faucet is disclosed in U.S. Pat. No. 7,467,874 and contains a shower head, wherein the shower head has an outlet pipe to flow water and guide lights, the shower head also has plural LED elements to illuminate the lights via the outlet pipe.

The conventional illuminative faucet also contains an electric wire electrically connected with a power supply and extending to the shower head from an inlet segment of the pull-out faucet along a flexible pipe. However, the electric wire is mounted on an outer wall of an internal tube of the flexible pipe, and a fitting casing or a woven cloth covers on the internal tube, such that the electric wire is mounted between the internal tube and the fitting casing or the woven cloth to cause complicated assembly. In addition, the electric wire is broken easily as rotating the shower head and a rotation angle of the shower head is limited.

A conventional pull-out faucet contains a shower head, and the shower head has a conduit member connected with an outlet segment of a flexible pipe by using its connector, such that the shower head is rotated. The pull-out faucet also contains a guiding member disposed on a bottom end of the conduit member, and the guiding member has a central channel and a peripheral channel; an internal sleeve fitted with the conduit member and the guiding member; an external sleeve fitted on the internal sleeve; a switch device having a button, a valve core driven by the button to move, such that the valve core guides water to flow out of the central channel or the peripheral channel from the conduit member. The pull-out faucet further contains a resilient element for pushing the valve core to move back to an original position.

The outlet segment of the flexible pipe is configured in the shower head so that the electric wire extends out of the outlet segment of the flexible pipe, but the outlet segment is located on an outer wall of the shower head, so the electric wire exposes outside the shower head.

As desiring to affix the switch device in the pull-out faucet, the circuit board (such as a PCB) is arranged in the shower head difficultly because of a narrow space of the shower head. Furthermore, the electric wire is broken as rotating the shower head.

The present invention has arisen to mitigate and/or obviate the afore-described disadvantages.

### SUMMARY OF THE INVENTION

The primary objective of the present invention is to provide a pull-out faucet which is assembled easily and quickly, decreases its production cost, avoids damage an electric wire in the pull-out faucet, and illuminates lights from a shower assembly.

To obtain the above objective, a pull-out faucet provided by the present invention contains: a body and a shower assembly mounted on the body; the shower assembly including a flexible pipe inserted into the body, an inflow member connected with an inlet segment of the flexible pipe to flow water, a spray head coupled with an outlet segment of the flexible pipe and retracted back to an outlet of the body after being pulled outwardly, a plurality of LED elements arranged in the spray head, a circuit board electrically connected with the plurality of LED elements, and an electric wire inserted into the flexible pipe and electrically connected with the circuit board to supply power.

The electric wire is inserted into the flexible pipe along a tunnel of the flexible pipe.

The spray head includes a light conductor, a conduit member above the light conductor, an internal sleeve fitted onto an outer wall of the conduit member, and an external sleeve fitted onto an outer wall of the internal sleeve.

A first stopper is disposed in the conduit member and has a first orifice to extend out of the electric wire from the outlet segment of the flexible pipe to electrically connect with the circuit board.

A second stopper is fixed on the inflow member and has a second orifice so as to insert the electric wire from the inlet segment of the flexible pipe.

The first stopper is made of rubber.

The second stopper is made of rubber.

The conduit member has an inlet chamber formed on an upper side thereof, an outlet chamber arranged on a lower side thereof, at least one passage communicating with the inlet chamber and the outlet chamber, a piston portion defined between the inlet chamber and the outlet chamber and matingly contacting with an inner wall of the internal sleeve, a receiving chamber defined between the inlet chamber and the piston portion; the inlet chamber has a first aperture formed on an inner wall thereof to contact with the first stopper.

The light conductor is a guiding member, and the guiding member has a peripheral fence and a horizontal fence coupling with the peripheral fence; the horizontal fence has a central channel passing therethrough; the peripheral fence has plural peripheral channels passing therethrough; the spray head further includes a switch device operated manually to control the water to flow out of the central channel or the plural peripheral channels of the light conductor via the conduit member.

The light conductor has plural input faces for inputting the lights, a light transmission portion for transmitting the lights, and an output face for outputting the lights; the circuit board is a flexible printed circuit and includes a longitudinal sheet, a C-shaped ring joining with the longitudinal sheet, and plural extensions extending toward the central axis X of the spray head; wherein the longitudinal sheet longitudinally extends between the internal sleeve and the external sleeve; the C-shaped ring surrounds around an inner wall of the light conductor and is defined between the light conductor and the internal sleeve; each extension is located above each input face, and a bottom face of each extension electrically connects with each LED element and faces to each input face.

The peripheral fence also has plural slots defined thereon to accommodate the plural extensions of the circuit board, wherein bottom surfaces of the plural slots form the plural input faces, and a bottom end of the light conductor forms the output face, among the plural input faces and the output face forms the light transmission portion.

The inflow member includes a connector, a tube, a seat, a U-shaped bolt, and the second stopper; a first end of the connector is inserted into the inlet segment of the flexible pipe; and the tube is screwed with a second end of the connector and has a passageway defined therein, a holder extending outwardly from an outer wall thereof, a trench formed on the holder, and two second apertures communicating with the trench; wherein the holder is cylindrical and retains with the trench, and the holder does not remove from the trench by inserting the U-shaped bolt through the two second apertures; the second stopper retains in the holder, wherein the electric wire inserts into the tube and then extends into the conduit member of the spray head along the connector and a tunnel of the flexible pipe.

The shower assembly further includes a coupling member for coupling the spray head with the outlet segment of the flexible pipe, the shower assembly further includes an angle limiter fixed between the spray head and the coupling member to limit a rotation of the spray head within a first angle range relative to the flexible pipe.

The spray head further includes a guiding member retained with a lower side of the conduit member, and the guiding member has a peripheral fence and a horizontal fence coupling with the peripheral fence; the horizontal fence has a central channel passing therethrough; the light conductor is disposed on a peripheral side of the guiding member and has at least one input face for inputting lights, at least one light transmission portion for transmitting the lights, and at least one output face for outputting the lights.

The light conductor has a circular rib and plural light columns extending upwardly from an inner wall of the circular rib, wherein each light column has an input face formed on a top end thereof, and bottom ends of the plural light columns and a bottom end of the circular rib define the at least one output face, the plural light columns form the at least one light transmission portion.

The light conductor is formed in a sleeve shape to retain with the guiding member, wherein the light conductor has an outer cliff, and the outer cliff has plural indentations arranged around a middle section thereof, wherein each indentation has an input face formed on a bottom end thereof, and the outer cliff also has an output face defined on a bottom end thereof, the outer cliff among input faces of the plural indentations and the output face forms the light transmission portion.

The circuit board is a flexible printed circuit and includes a longitudinal sheet and a C-shaped ring joining with the longitudinal sheet; wherein the longitudinal sheet longitudinally extends between the internal sleeve and the external sleeve; the plurality of LED elements are arranged on an inner wall of the C-shaped ring and retain in the plural indentations to illuminate the input faces of the plural indentations.

Accordingly, the pull-out faucet of the present invention contains the flexible printed circuit to replace a conventional circuit board, and the electric wire is fixed into the flexible pipe by ways of the inflow member, the first stopper and the second stopper of the conduit member to avoid damage as rotating the spray head of the shower assembly.

### BRIEF DESCRIPTION OF THE DRAWINGS

FIG. 1 is a perspective view showing the assembly of a pull-out faucet according to a first embodiment of the present invention.

FIG. 2 is a cross sectional view showing the assembly of the pull-out faucet according to the first embodiment of the present invention.

FIG. 3 is a perspective view showing the assembly of a shower assembly of the pull-out faucet according to the first embodiment of the present invention.

FIG. 4 is a cross sectional view showing the assembly of the shower assembly of the pull-out faucet according to the first embodiment of the present invention.

FIG. 5 is a cross sectional view showing the assembly of a part of the shower assembly of the pull-out faucet according to the first embodiment of the present invention.

FIG. 6 is another cross sectional view showing the assembly of a part of the shower assembly of the pull-out faucet according to the first embodiment of the present invention.

FIG. 7 is a perspective view showing the assembly of a light conductor of the pull-out faucet according to the first embodiment of the present invention.

FIG. 8 is a side plan view showing the assembly of the light conductor of the pull-out faucet according to the first embodiment of the present invention.

FIG. 9 is a cross sectional view taken along the line 1-1 of FIG. 8.

FIG. 10 is a cross sectional view taken along the line 2-2 of FIG. 8.

FIG. 11 is a perspective view showing the assembly of a circuit board and a plurality of LED elements of the pull-out faucet according to the first embodiment of the present invention.

FIG. 12 is a cross sectional view showing the assembly of the light conductor, the circuit board, and the plurality of LED elements of the pull-out faucet according to the first embodiment of the present invention.

FIG. 13 is an amplified cross sectional view of a portion A of FIG. 12.

FIG. 14 is a cross-sectional perspective view showing the assembly of an internal sleeve, an external sleeve, the circuit board, and the plurality of LED elements of the pull-out faucet according to the first embodiment of the present invention.

FIG. 15 is another cross-sectional perspective view showing the assembly of the internal sleeve, the external sleeve, the circuit board, and the plurality of LED elements of the pull-out faucet according to the first embodiment of the present invention.

FIG. 16 is a cross-sectional perspective view showing the assembly of a conduit member of the pull-out faucet according to the first embodiment of the present invention.

FIG. 17 is another cross-sectional perspective view showing the assembly of the conduit member of the pull-out faucet according to the first embodiment of the present invention.

FIG. 18 is a cross-sectional perspective view showing the assembly of the conduit member and an internal sleeve of the pull-out faucet according to the first embodiment of the present invention

FIG. 19 is a cross-sectional perspective view showing the assembly of an inflow member of the pull-out faucet according to the first embodiment of the present invention.

FIG. 20 is a cross-sectional perspective view showing the assembly of a coupling member and an angle limiter of the pull-out faucet according to the first embodiment of the present invention.

FIG. 21 is a cross-sectional perspective view showing the assembly of a first joining portion of the pull-out faucet according to the first embodiment of the present invention.

FIG. 22 is a side plan view showing the assembly of the first joining portion of the pull-out faucet according to the first embodiment of the present invention.

FIG. 23 is a perspective view showing the assembly of the angle limiter of the pull-out faucet according to the first embodiment of the present invention.

FIG. 24 is a cross sectional view taken along the line 3-3 of FIG. 23.

FIG. 25 is a perspective view showing the assembly of a first limitation element of the pull-out faucet according to the first embodiment of the present invention.

FIG. 26 is a perspective view showing the assembly of a second limitation element of the pull-out faucet according to the first embodiment of the present invention.

FIG. 27 is a cross sectional view showing the assembly of a part of a shower assembly of a pull-out faucet according to a second embodiment of the present invention.

FIG. 28 is a perspective view showing the assembly of a guiding member of the pull-out faucet according to the second embodiment of the present invention.

FIG. 29 is a cross-sectional perspective view showing the assembly of the guiding member of the pull-out faucet according to the second embodiment of the present invention.

FIG. 30 is a perspective view showing the assembly of a light conductor of the pull-out faucet according to the second embodiment of the present invention.

FIG. 31 is a cross-sectional perspective view showing the assembly of the guiding member, the light conductor, a circuit board and a plurality of LED elements of the pull-out faucet according to the second embodiment of the present invention.

FIG. 32 is a cross sectional view showing the assembly of a shower assembly of a pull-out faucet according to a third embodiment of the present invention.

FIG. 33 is a perspective view showing the assembly of a guiding member, a light conductor, a circuit board, and a plurality of LED elements of the pull-out faucet according to the third embodiment of the present invention.

FIG. 34 is a top plan view of FIG. 33.

FIG. 35 is a cross sectional view taken along the lines 4-4 of FIG. 34.

FIG. 36 is an amplified cross sectional view of a portion B of FIG. 35.

FIG. 37 is a perspective view showing the exploded components of the guiding member, the light conductor, and the circuit board of the pull-out faucet according to the third embodiment of the present invention.

### DETAILED DESCRIPTION OF THE PREFERRED EMBODIMENTS

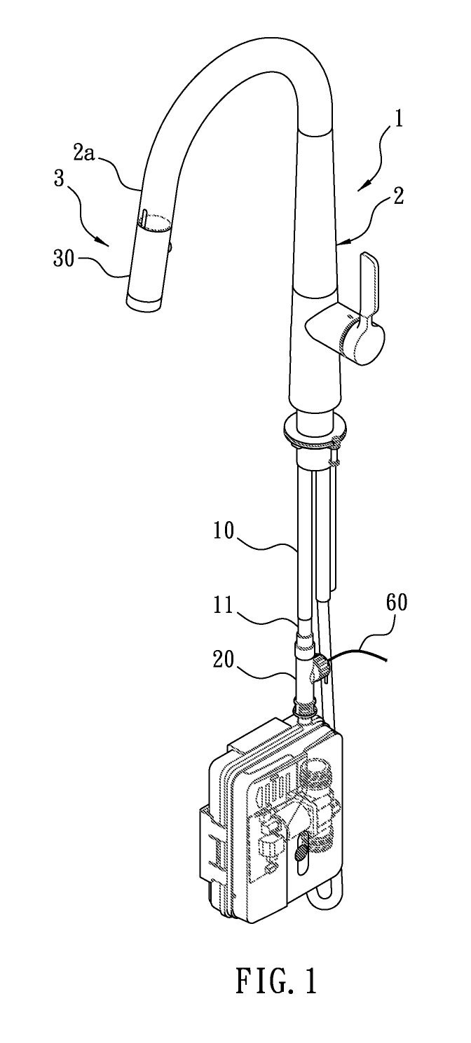

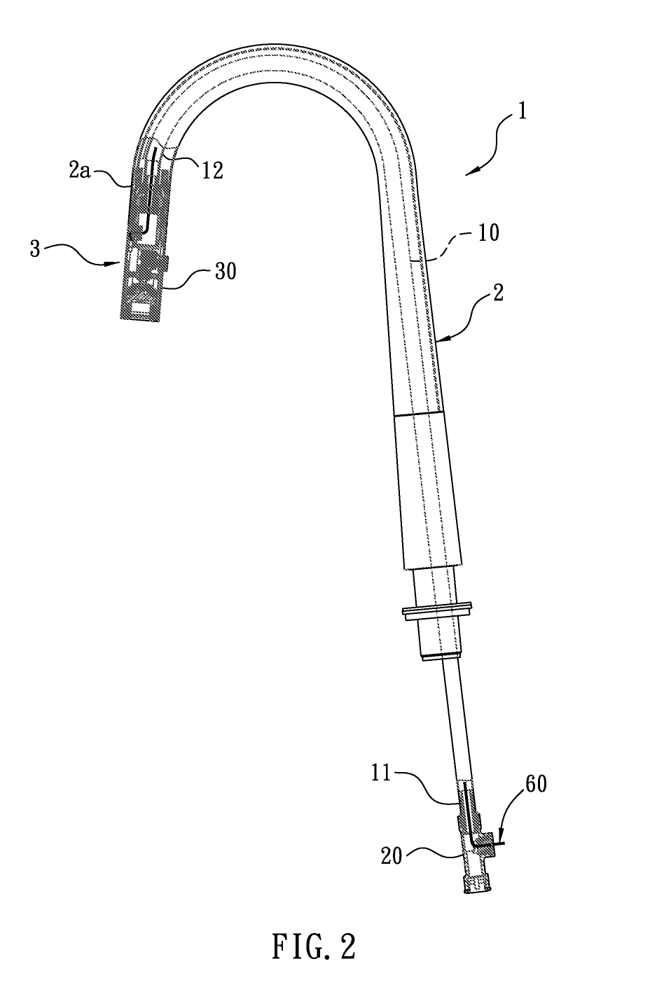

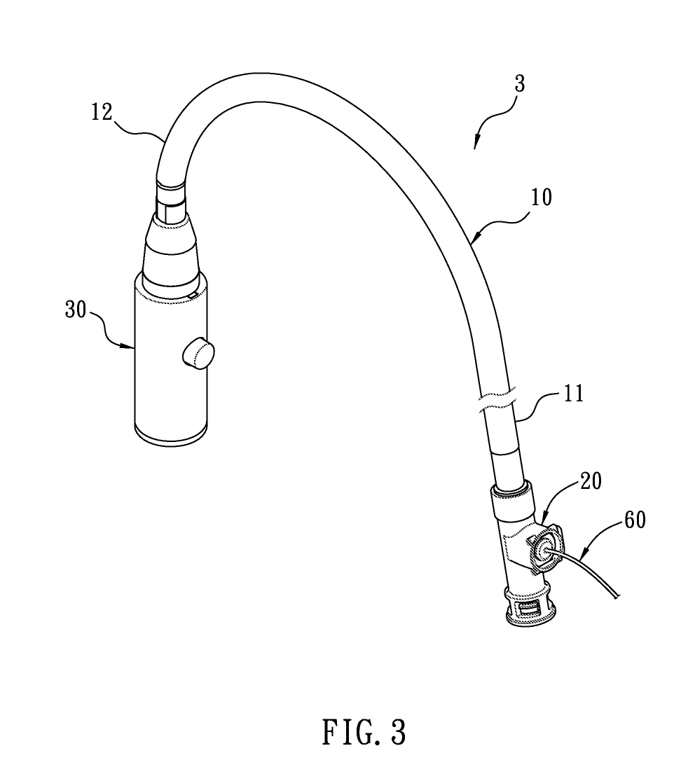

With reference to FIGS. 1 to 6, a pull-out faucet 1 according to a first embodiment of the present invention comprises: a body 2 and a shower assembly 3 mounted on the body 2; the shower assembly 3 including a flexible pipe 10 inserted into the body 2, an inflow member 20 connected with an inlet segment 11 of the flexible pipe 10 to flow water, a spray head 30 coupled with an outlet segment 12 of the flexible pipe 10 and retracted back to an outlet 2a of the body 2 after being pulled outwardly, a plurality of LED elements 40 arranged in the spray head 30, a circuit board 50 electrically connected with the plurality of LED elements 40, and an electric wire 60 inserted into the flexible pipe 10 and electrically connected with the circuit board 50 to supply power.

An improvement of the pull-out faucet is described in below disclosure.

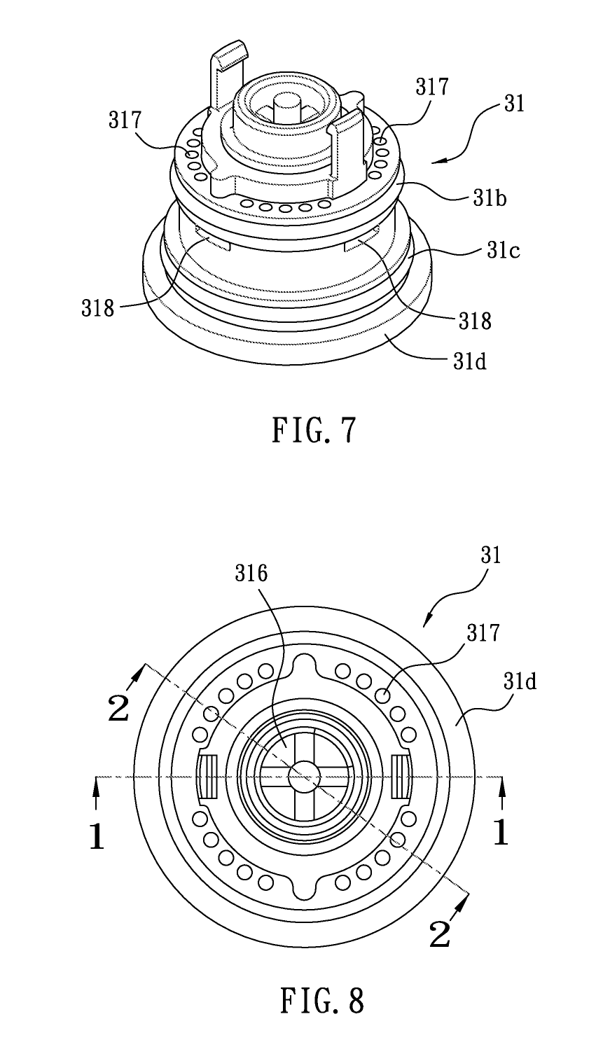

The spray head 30 includes a light conductor 31 made of translucent material to guide lights, as shown in FIGS. 7 to 10, the light conductor 31 has plural input faces 311 for inputting the lights, a light transmission portion 312 for transmitting the lights, and an output face 313 for outputting the lights.

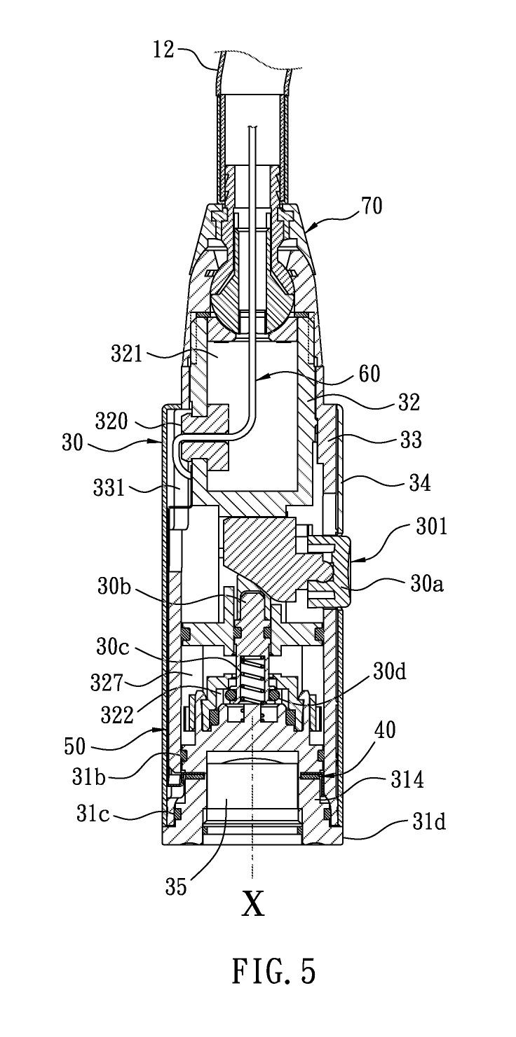

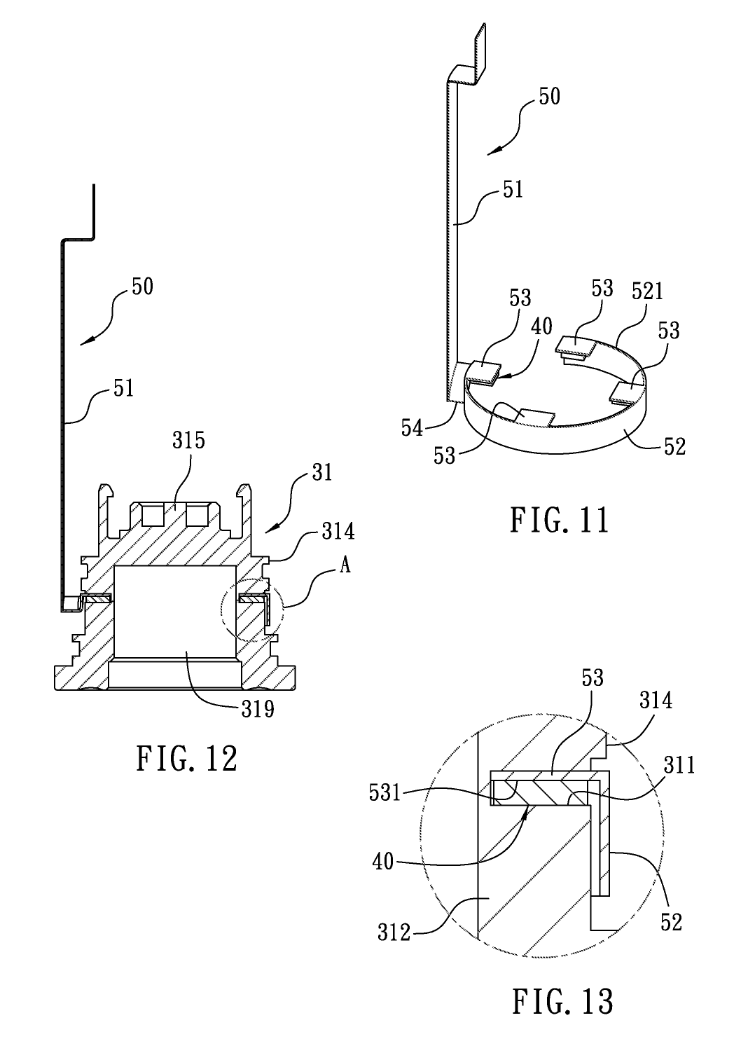

The circuit board 50, as illustrated in FIG. 11, is a flexible printed circuit (FPC) and includes a longitudinal sheet 51, a C-shaped ring 52 joining with the longitudinal sheet 51, plural extensions 53 extending toward a central axis X of the spray head 30, as shown in FIG. 5. In this embodiment, four extensions 53 isometrically extend around the C-shaped ring 52; wherein the longitudinal sheet 51 longitudinally extends into the spray head 30; the C-shaped ring 52 surrounds around an inner wall of the light conductor 31, as illustrated in FIG. 12; each extension 53 is located above each input face 311, and a bottom face 531 of each extension 53 electrically connects with each LED element 40 and faces to each input face 311.

The light conductor 31 is a guiding member, and the guiding member has a peripheral fence 314 and a horizontal fence 315 coupling with the peripheral fence 314; the horizontal fence 315 has a central channel 316 passing therethrough, wherein the central channel 316 are defined by four through holes; the peripheral fence 314 has plural peripheral channels 317 passing therethrough; the peripheral fence 314 also has plural slots 318 defined thereon to accommodate the plural extensions 53 of the circuit board 50, wherein bottom surfaces of the plural slots 318 form the plural input faces 311, and a bottom end of the light conductor 31 forms the output face 313; wherein between the horizontal fence 315 and the peripheral fence 314 is defined an accommodating cavity 319 which is in communication with the central channel 316, and the accommodating cavity 319 accommodates a faucet aerator 35, as shown in FIG. 5.

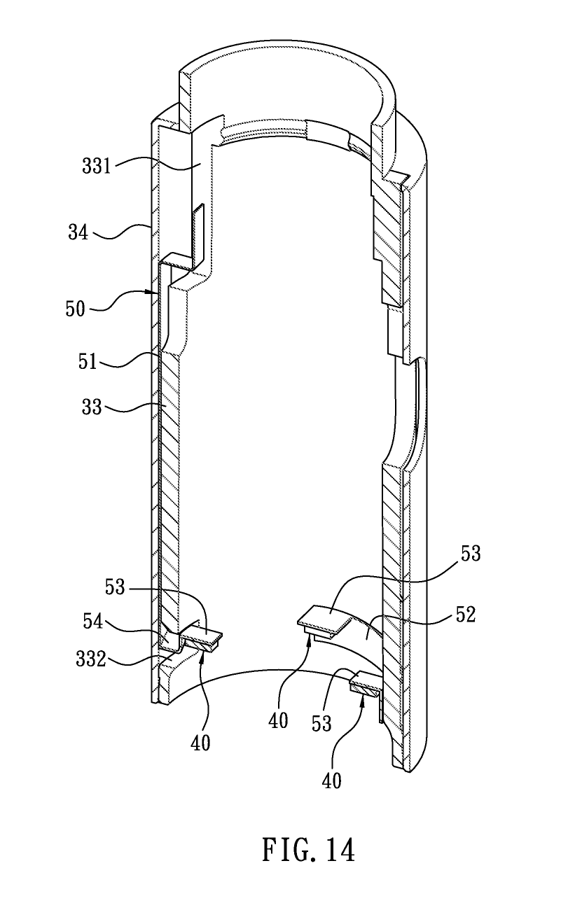

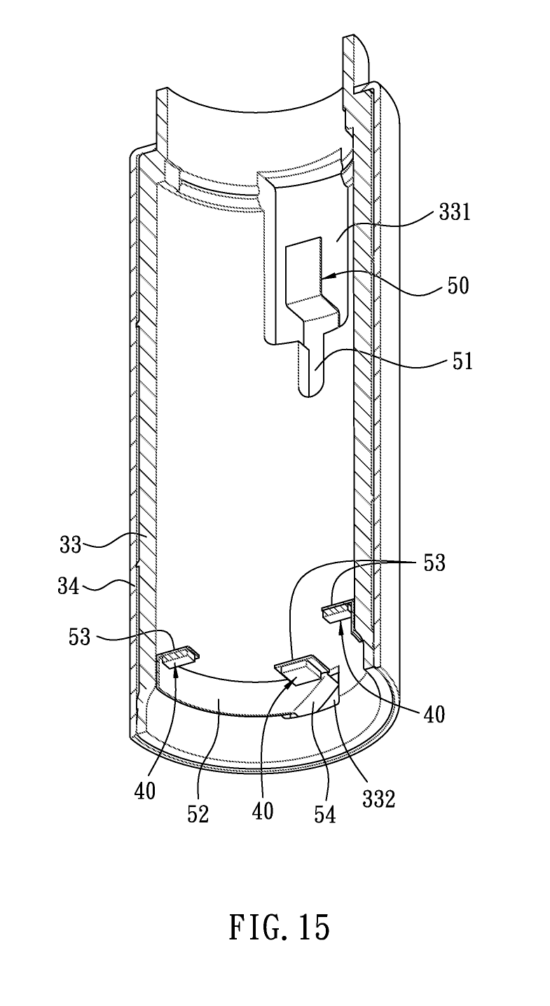

With reference to FIG. 5, the spray head 30 further includes a conduit member 32, an internal sleeve 33 fitted onto an outer wall of the conduit member 32, and an external sleeve 34 fitted onto an outer wall of the internal sleeve 33; as illustrated in FIGS. 14 and 15, the longitudinal sheet 51 of the circuit board 50 is defined between the internal sleeve 33 and external sleeve 34, and the C-shaped ring 52 is defined between the light conductor 31 and the internal sleeve 33.

The internal sleeve 33 has a first receiving portion 331 for inserting the electric wire 60 and a second receiving portion 332; the circuit board 50 further includes a connecting sheet 54 connecting with a bottom end of the longitudinal sheet 51 and the C-shaped ring 52, as shown in FIGS. 11 and 14, and inserting through the second receiving portion 332 of the internal sleeve 33.

Referring to FIG. 5, the spray head 30 further includes a switch device 301 operated manually by a user to control the water to flow out of the central channel 316 or the plural peripheral channels 317 of the light conductor 31 via the conduit member 32.

The switch device 301 has a button 30a pressed manually by the user, a valve core 30b mounted on the conduit member 32 and pushed by the button 30a to move between a first closing position and a second closing position, a resilient element 30c fixed between a top end of the light conductor 31 and a bottom end of the valve core 30b to elastically abut against the valve core 30b to move back to the first closing position. When the spray head 30 is in a water stop state, the valve core 30b is pushed by the resilient element 30c to maintain at the first closing position, such that after turning on the pull-out faucet, the water is guided to flow out of the central channel 316 through the conduit member 32, and the button 30a is pressed by the user to push the valve core 30b to move toward the second closing position, thereafter the water is guided to flow out of the plural peripheral channels 317 via the conduit member 32. Since the switch device 301 is a well-known art, further remarks are omitted.

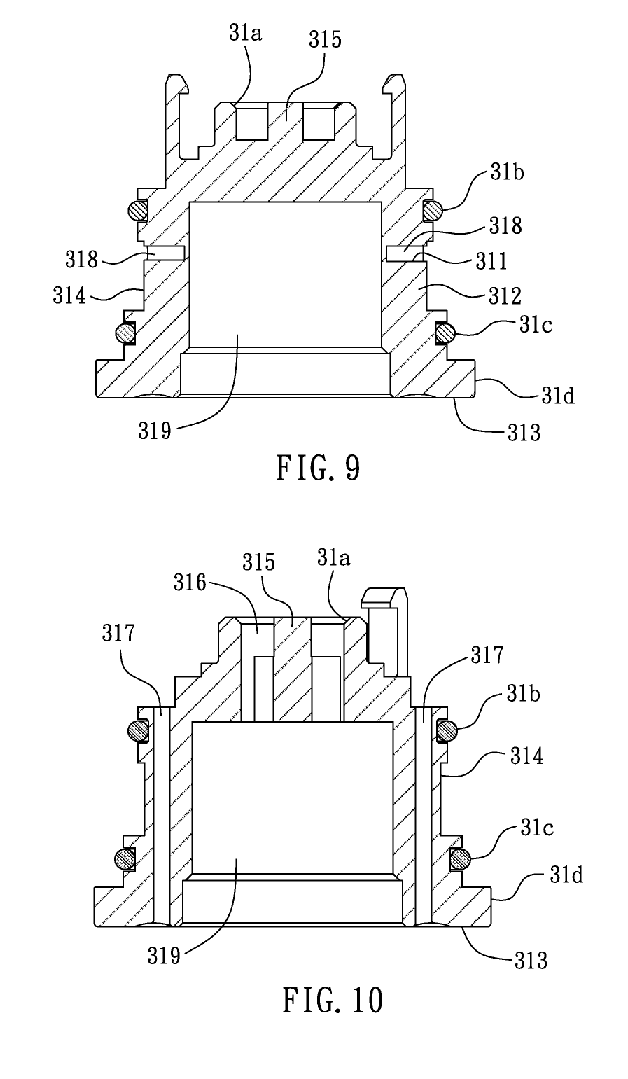

With reference to FIGS. 5, 16 and 17, the conduit member 32 has an inlet chamber 321 formed on an upper side thereof, an outlet chamber 322 arranged on a lower side thereof, two passages 323 communicating with the inlet chamber 321 and the outlet chamber 322, a piston portion 324 defined between the inlet chamber 321 and the outlet chamber 322 and matingly contacting with the inner wall of the internal sleeve 33, a receiving chamber 325 defined between the inlet chamber 321 and the piston portion 324 to accommodate the button 30a of the switch device 301; the light conductor 31 retains with the lower end of the conduit member 32, and the central channel 316 of the horizontal fence 315 is in communication with the outlet chamber 322, the plural peripheral channels 317 on the horizontal fence 315 are located outside the outlet chamber 322; between the piston portion 324 and the outlet chamber 322 are defined a first orifice 326 and an outer room 327 which communicates with the first orifice 326 and the plural peripheral channels 317 of the light conductor 31, wherein the valve core 30b of the switch device 301 slides in the first orifice 326 along the central axis X of the spray head 30; the valve core 30b has a close washer 30d to move with the button 30a and pushed by the resilient element 30c to vertically move in the outlet chamber 322, when the valve core 30b moves upwardly to contact with a first sealing fringe 328 in the outlet chamber 322, the water in the outlet chamber 322 is guided to flow to the central channel 316 of the light conductor 31, in the meantime, the valve core 30b is located at the first closing position; as shown in FIGS. 9 and 10, when the valve core 30b moves downwardly to matingly contact with a second sealing fringe 31a on the horizontal fence 315 to stop the water from the central channel 316, the water is guided to flow out of the outer room 327 and the plural peripheral channels 317, in the meantime, the valve core 30b is located at the second closing position.

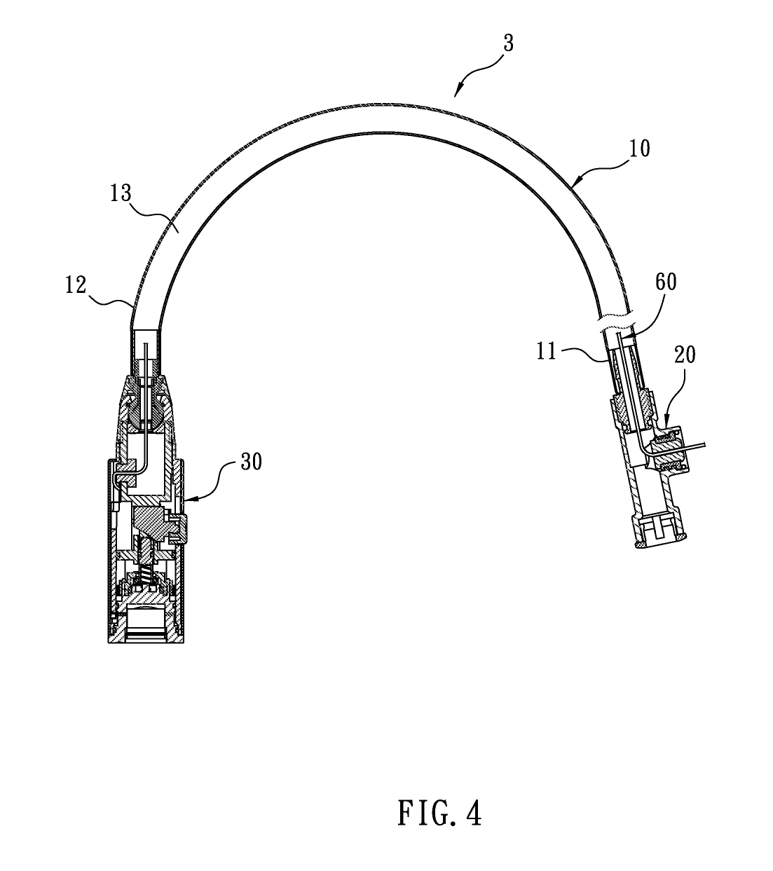

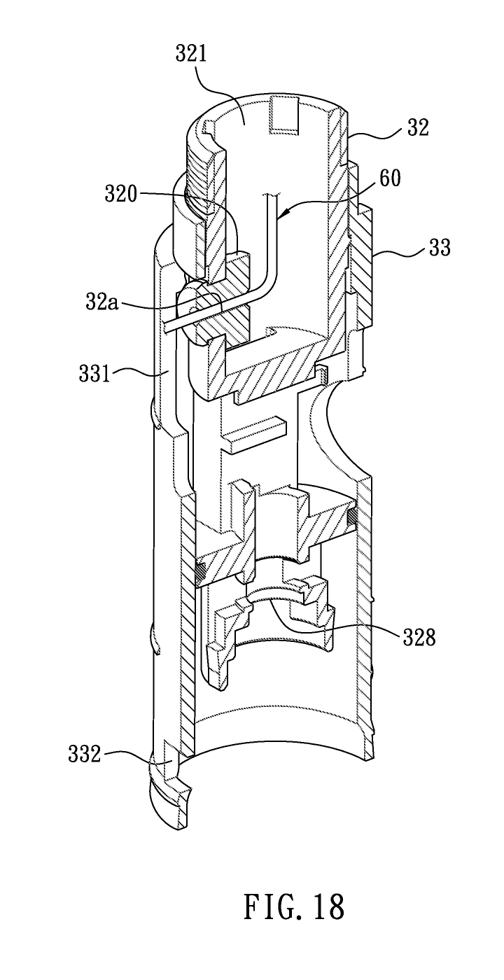

With reference to FIGS. 4, 16 and 18, the inlet chamber 321 has a first aperture 329 formed on an inner wall thereof to contact with a first stopper 320 made of rubber, the first stopper 320 has a second orifice 32a defined therein to extend the electric wire 60 out of the second orifice 32a of the first receiving portion 331 of the internal sleeve 33.

Referring further to FIGS. 5, 7 and 10, each slot 318 of the peripheral fence 314 of the light conductor 31 further has a first stopping portion 31b arranged on an upper side of an outer wall thereof and has a second stopping portion 31c arranged on a lower side of the outer wall thereof to close the internal sleeve 33, thus stopping the water flowing into the outer room 327 of the conduit member 32 and penetrating to the plurality of LED elements 40 and the circuit board 50 between the first stopping portion 31b and the second stopping portion 31c. The light conductor 31 further has a circular rib 31d extending outwardly from a lower side of an outer wall of the second stopping portion 31c opposite to the internal sleeve 33 and the external sleeve 34, such that the circular rib 31d exposes outside to enhance illumination effect.

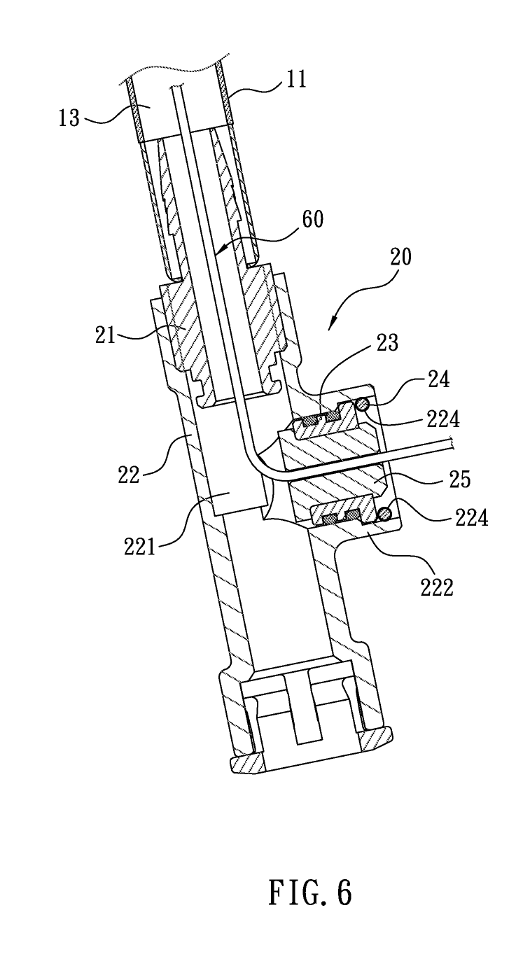

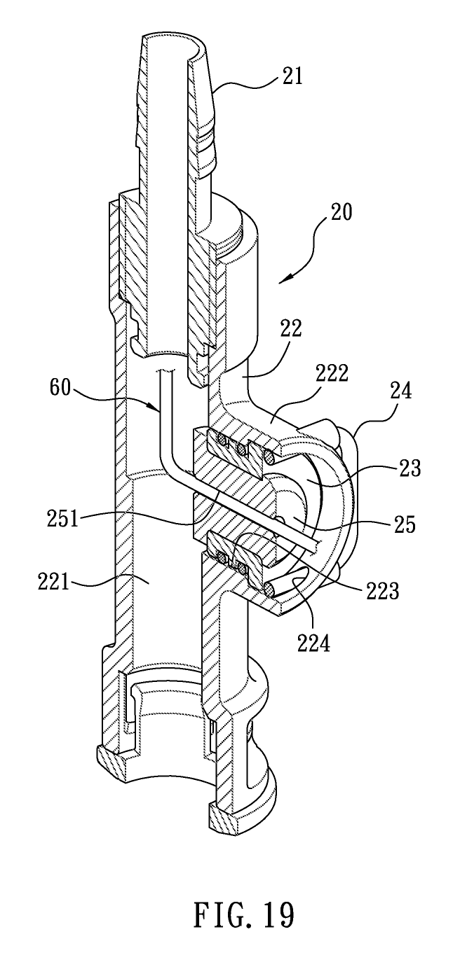

As shown in FIGS. 6 and 19, the inflow member 20 includes a connector 21, a tube 22, a seat 23, a U-shaped bolt 24, and a second stopper 25; a first end of the connector 21 is inserted into the inlet segment 11 of the flexible pipe 10; and the tube 22 is screwed with a second end of the connector 21 and has a passageway 221 defined therein, a holder 222 extending outwardly from an outer wall thereof, a trench 223 formed on the holder 222, and two second apertures 224 communicating with the trench 223; wherein the holder 23 is cylindrical and retains with the trench 223, and the holder 23 does not remove from the trench 223 by inserting the U-shaped bolt 24 through the two second apertures 224; the second stopper 25 is made of rubber and retains in the holder 23, wherein the second stopper 25 has a third orifice 251 so that the electric wire 60 inserts into the tube 22 from the third orifice 251 and then extends into the conduit member 32 of the spray head 30 along the connector 21 and a tunnel 13 of the flexible pipe 10.

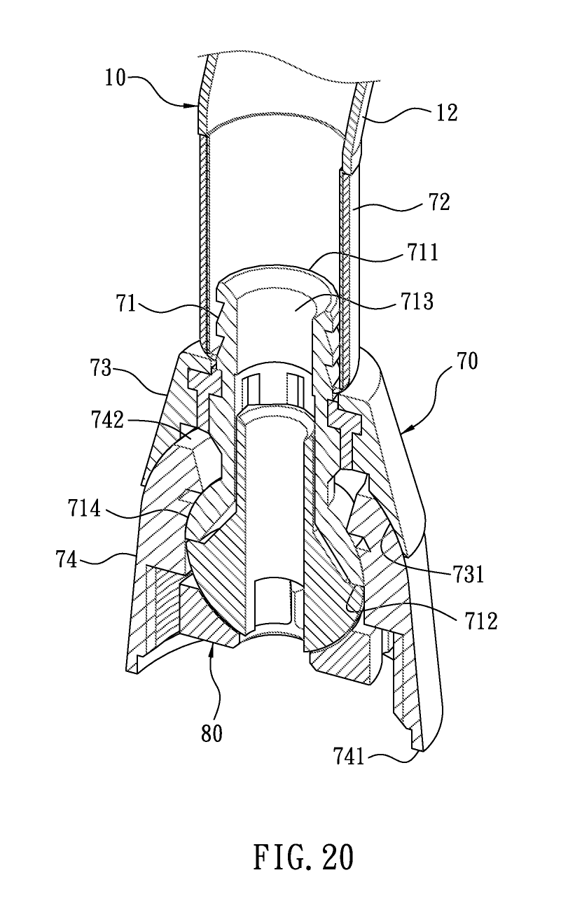

As illustrated in FIGS. 5 and 20, the shower assembly 3 further includes a coupling member 70 for coupling the spray head 30 with the outlet segment 12 of the flexible pipe 10, the shower assembly 3 further includes an angle limiter 80 fixed between the spray head 30 and the coupling member 70 to limit a rotation of the spray head 30 within a first angle range relative to the flexible pipe 10.

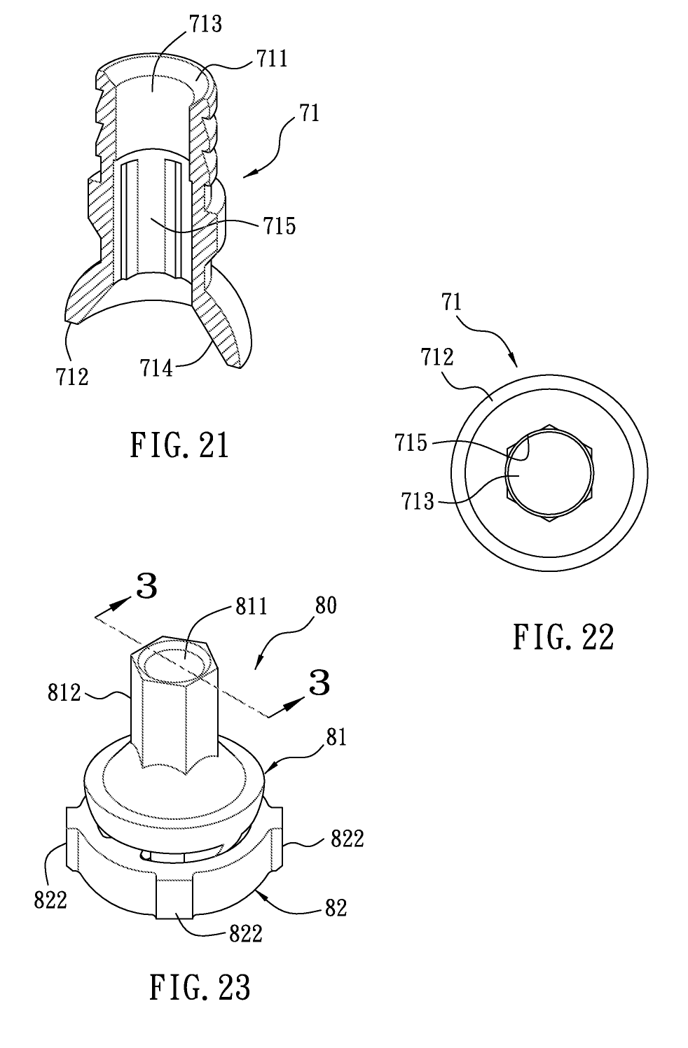

The coupling member 70 includes a first joining portion 71, a limiting loop 72, a bushing 73, and a second joining portion 74; the first joining portion 71 has a first inner segment 711, an first outer segment 712, and an opening 713 passing through the first inner segment 711 and the first outer segment 712; the first inner segment 711 is inserted into the outlet segment 12 of the flexible pipe 10, and the first outer segment 712 has a first spherical face 714 formed on an outer wall thereof, the opening 713 has a locking notch 715, as illustrated in FIGS. 21 and 22. The limiting loop 72 retains on an outer wall of the outlet segment 12 of the flexible pipe 10, such that the first inner segment 711 of the first joining portion 71 retains in the outlet segment 12 of the flexible pipe 10. The bushing 73 is limited between the limiting loop 72 and an inner wall of the first joining portion 71 adjacent to the first inner segment 711, and the bushing 73 has a second spherical face 731 formed on an inner wall thereof. The second joining portion 74 has a second outer segment 741 and a second inner segment 742; the second outer segment 741 screws with an upper side of the conduit member 32 of the spray head 3, the second inner segment 742 is limited between the first spherical face 714 of the first spherical face 714 and the second spherical face 731 of the bushing 73, such that the second joining portion 74 rotates freely so that the spray head 30 is rotated smoothly.

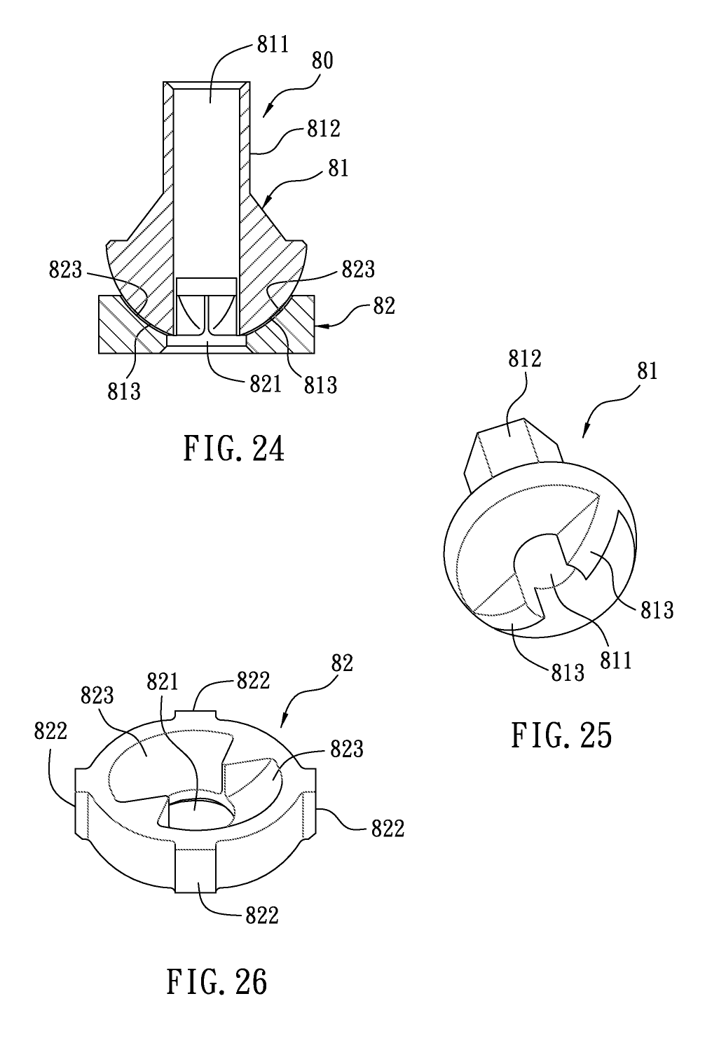

With reference to FIGS. 23 and 24, the angle limiter 80 includes a first limitation element 81 inserted into the locking notch 715 of the first joining portion 71, wherein the first limitation element 81 has a first pore 811 defined therein to insert through the electric wire 60 from the opening 713; a second limitation element 82 is fixed on the upper side of the conduit member 32, as shown in FIG. 5, wherein the second limitation element 82 has a second pore 821 corresponding to the first pore 811, such that the electric wire 60 is inserted into the inlet chamber 321 of the conduit member 32 from the first pore 811 via the second pore 821. In addition, the second limitation element 82 is biased against a bottom end of the first limitation element 81, thus limiting a rotation of the second limitation element 82 relative to the first imitation element 81 within a second angle range. Due to the conduit member 32 is a component of the spray head 30, the first joining portion 71 is joined with the outlet segment 12 of the flexible pipe 10, the angle limiter 80 limits rotations of the spray head 30 and the flexible pipe 10 within a third angle range to avoid the electric wire 60 rotation overly with the flexible pipe 10 and the spray head 30.

To fix a top end of the first limitation element 81 in the locking notch 715 of the first joining portion 71, the locking notch 715 is formed in a polygon shape, such as a hexagon, and a bolt head 812 is formed in a polygon shape on the top end of the first limitation element 81, thus fixing the first limitation element 81 in the locking notch 715.

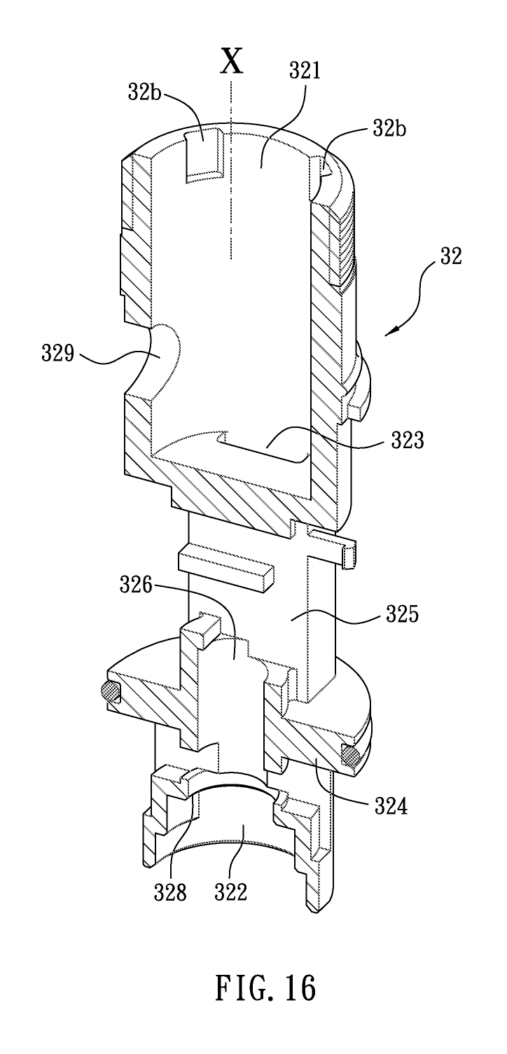

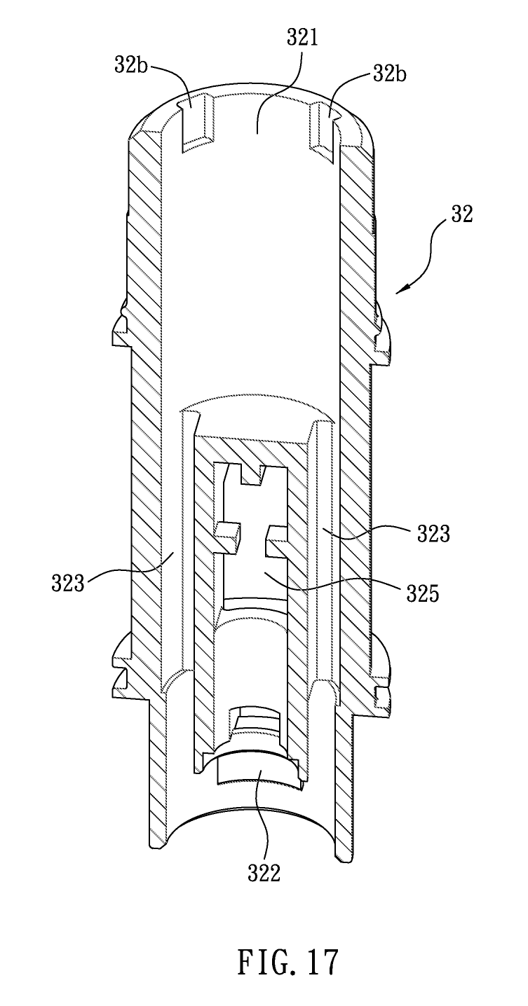

To position the second limitation element 82 on the upper side of the conduit member 32, the inlet chamber 321 of the conduit member 32 has plural recesses 32b formed on the inner wall thereof, as illustrated in FIGS. 16 and 17, and the second limitation element 82 has a plurality of retainers 822 arranged on a peripheral side thereof to retain with the plural recesses 32b.

Referring to FIGS. 25 and 26, to limit rotations of the first limitation element 81 and the second limitation element 82 within a fourth angle range, the first limitation element 81 has two confining blocks 813 symmetrically formed on the bottom end thereof, and the second limitation element 82 has two troughs 823 symmetrically arranged thereon, such that the two confining blocks 813 contact with and rotate in the two troughs 823. In this embodiment, the first limitation element 81 and the second limitation element 82 rotate within 110 degrees.

Preferably, a contact zone of each confining block 813 and each trough 823 is an arcuate surface, hence the first limitation element 81 and the second limitation element 83 revolve with the spray head 30, and the spray head 30 rotates smoothly with the second joining portion 74 to avoid being interfered by the angle limiter 80.

Before assembling the pull-out faucet completely, the circuit board 50, the plurality of LED elements 40, and the electric wire 60 are electrically connected together. In other words, the C-shaped ring 52 and the plural extensions 53 of the circuit board 50 and the plurality of LED elements 40 are mounted on the light conductor 31, and then the connecting sheet 54 and the longitudinal sheet 51 are fixed between the internal sleeve 33 and the external sleeve 34, thereafter the electric wire 60 is inserted through the first receiving portion 331 of the internal sleeve 33, the first aperture 329 of the conduit member 32 and the inlet chamber 321, and the first stopper 320 is installed on the first aperture 329 of the conduit member 32, thus connecting the spray head 30 completely. Further, the electric wire 60 is inserted through the angle limiter 80 and the coupling member 70 on the outlet segment 12 of the flexible pipe 10 and extends out of the holder 23 of the inflow member 20 via the flexible pipe 10. Finally, the conduit member 32, the angle limiter 80 and the coupling member 70 are coupled together, and then the tube 22 is screwed with the connector 21 which is fixed on the inlet segment 11 of the flexible pipe 10, the second stopper 25 is pushed into the holder 23, thus assembling the shower assembly 3 quickly.

Preferably, most components of the pull-out faucet of the present invention are well-known art, such as the internal sleeve 33, the external sleeve 34, and the switch device 301 of the spray head 30, the coupling member 70, and the flexible pipe 10, except for the light conductor 31, the conduit member 32, and the inflow member 20, and other additional components, thus reducing design and production costs and maintaining original appearance and size of the pull-out faucet.

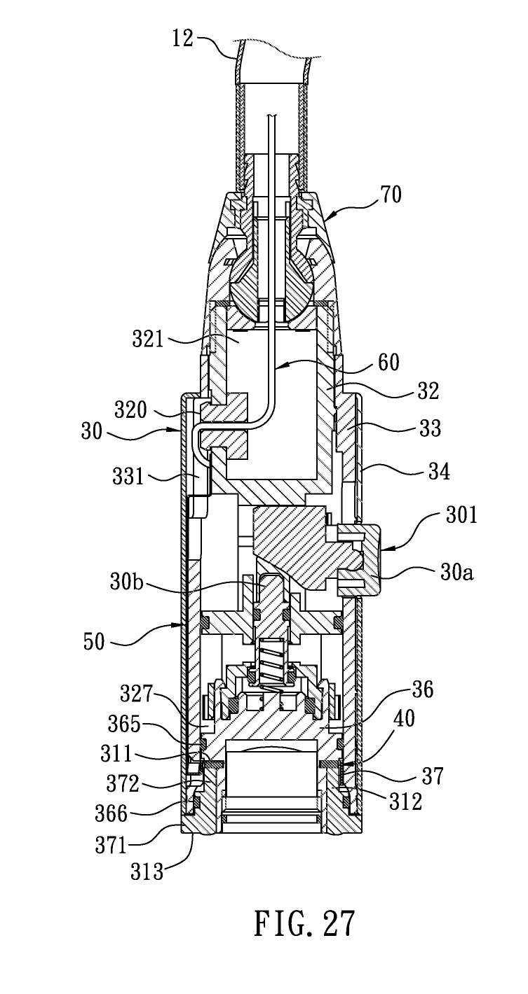

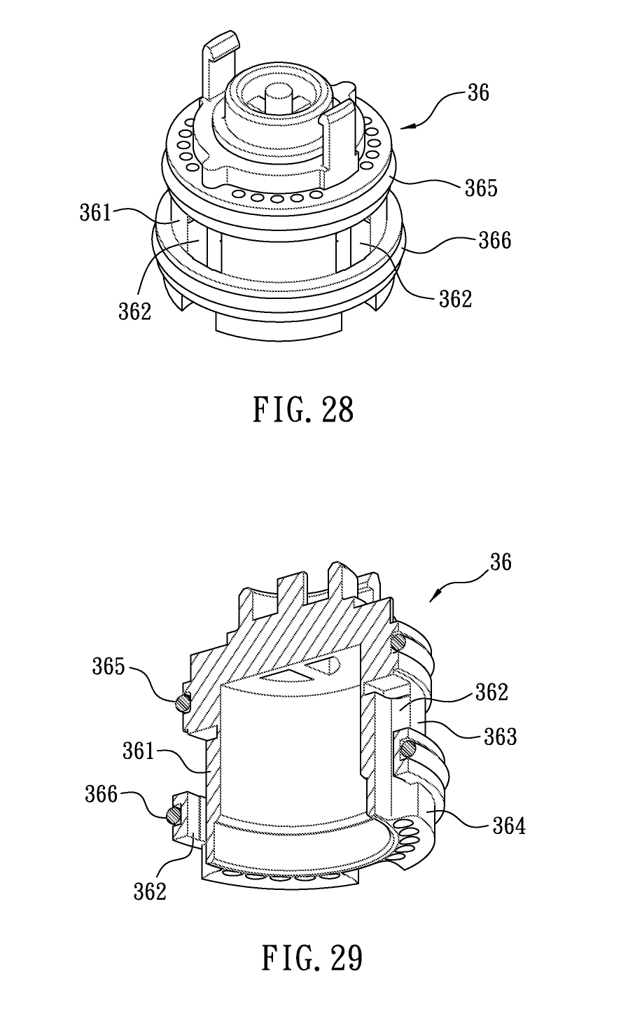

With reference to FIGS. 27 to 29, a pull-out faucet of a second embodiment from that of the first embodiment comprises: a guiding member 36, wherein the conducting member 36 does not conduct and penetrate the lights, so it does not have the plural input faces 311, the light transmission portion 312, and the output face 313 of the light conductor 31 of the first embodiment.

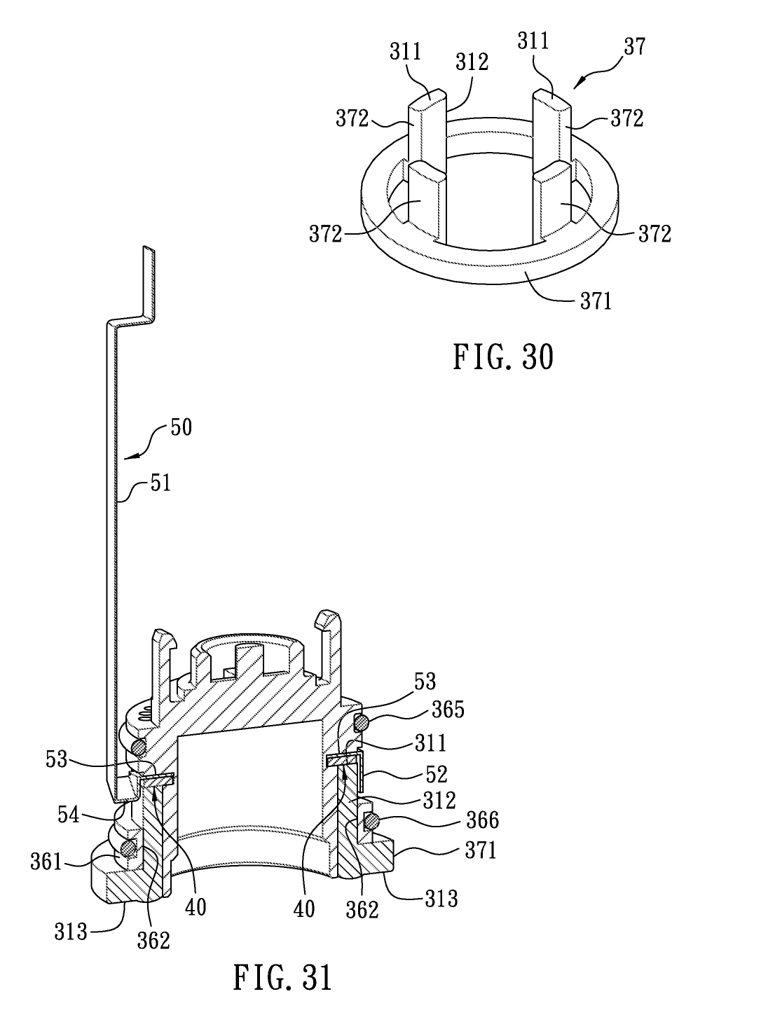

Referring further to FIGS. 30 and 31, the pull-out faucet of the second embodiment further includes a light conductor 37 disposed on a peripheral side of the guiding member 36, and the light conductor 37 has a circular rib 371 and plural light columns 372 extending upwardly from an inner wall of the circular rib 371, wherein each light column 372 has an input face 311 formed on a top end thereof, and bottom ends of the plural light columns 372 and a bottom end of the circular rib 371 define at least one output face 313, the plural light columns 372 form at lease one light transmission portion 312.

To fix the light conductor 37, a peripheral fence 361 of the guiding member 36 has a plurality of slits 362 extending upwardly from a bottom end of the peripheral fence 361 to insert the plural light columns 372 of the light conductor 37, and the peripheral fence 361 has a first gap 363 and a second gap 364 which both communicate with the plurality of slits 362, such that a C-shaped ring 52 of a circuit board 50 is fixed around the plural light columns 372 via the first gap 363, and each of a plurality of LED elements 40 on each of the plural extensions 53 of the circuit board 50 faces to the input face 311 of each light column 372.

Each light column 372 is fixed in each slit 362 in an engagement manner or an adhesion manner.

The peripheral fence 361 of the guiding member 36 has a first stopping portion 365 disposed above the first gap 363 thereof, and the peripheral fence 361 also has a second stopping portion 366 defined between the first gap 363 and the second gap 364 of the peripheral fence 361, such that the first stopping portion 365 and the second stopping portion 366 contact with an inner wall of an internal sleeve 33, thus stopping water flowing into an outer room 327 of the conduit member 32 and penetrating to the plurality of LED elements 40 and the circuit board 50 between the first stopping portion 365 and the second stopping portion 366. A top end of the circular rib 371 of the light conductor 37 is opposite to a bottom end of the second stopping portion 366, a bottom end of the internal sleeve 33, and a bottom end of an external sleeve 34, such that the circular rib 371 exposes outside to enhance light transmission and illumination.

A difference of the assembly of the pull-out faucet of the second embodiment from that of the first embodiment comprises: the light conductor 37 being inserted onto the guiding member 36 to connect with the circuit board 50 and the plurality of LED elements 40 further, thus assembling the pull-out faucet easily.

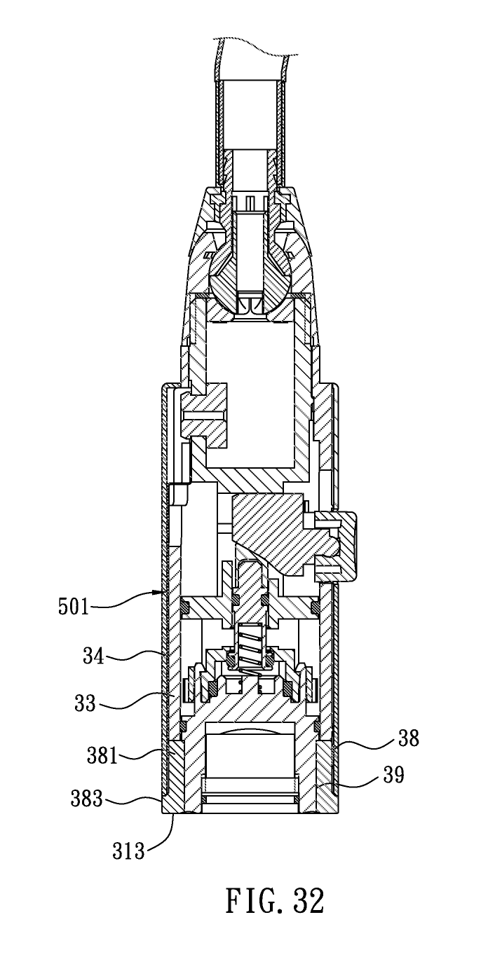

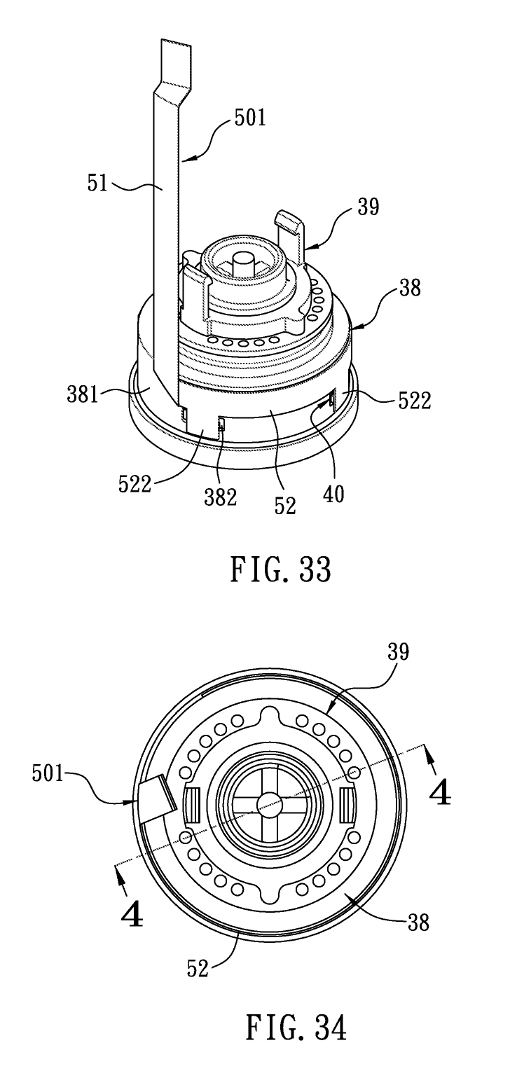

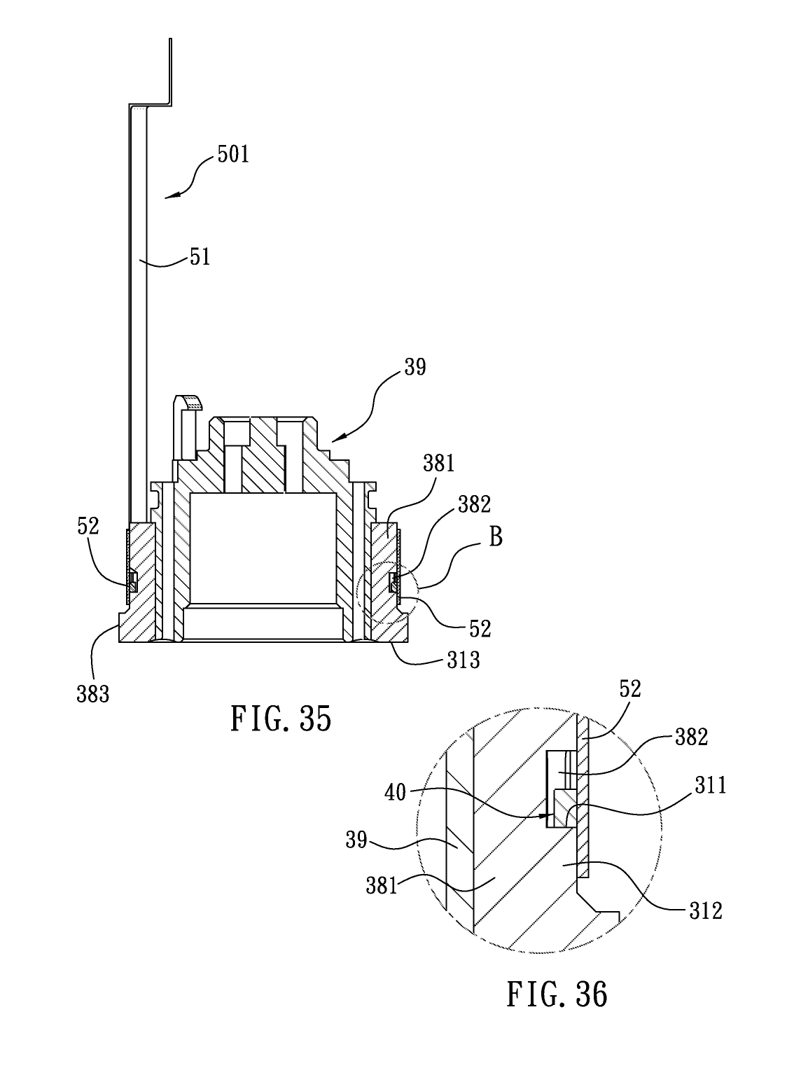

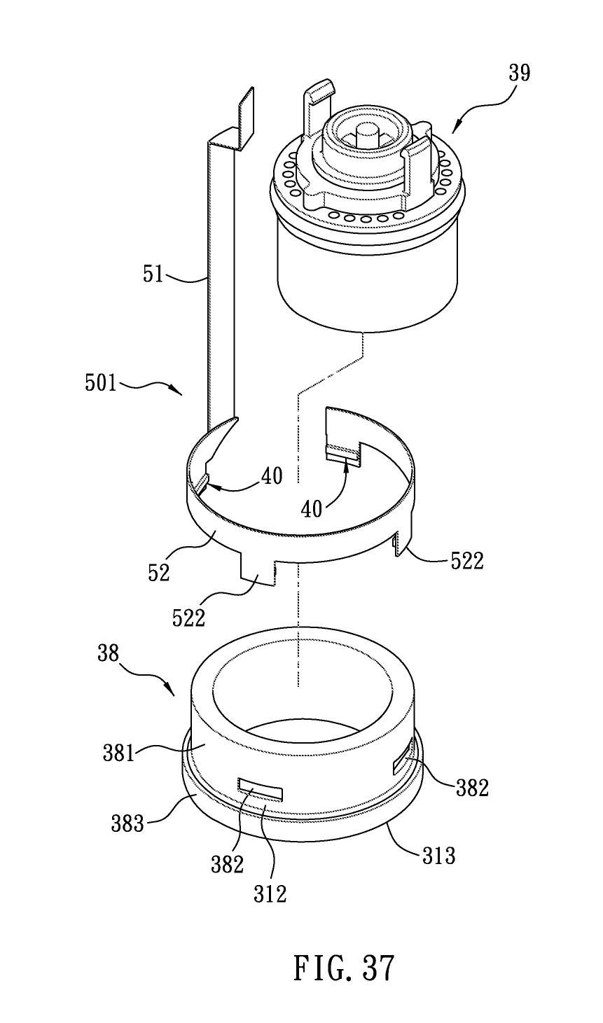

With reference to FIGS. 32 to 37, a difference of a pull-out faucet of a third embodiment from that of the second embodiment comprises:

a light conductor 38 formed in a sleeve shape to retain with a guiding member 39, wherein the light conductor 38 has an outer cliff 381, and the outer cliff 381 has plural indentations 382 arranged around a middle section thereof, wherein each indentation 382 has an input face 311 formed on a bottom end thereof, and the outer cliff 381 also has an output face 313 defined on a bottom end thereof. In addition, the outer cliff 381 among input faces 311 of the plural indentations 382 and the output face 313 forms a light transmission portion 312.

To enhance light transmission, the outer cliff 381 of the light conductor 38 has an annular protrusion 383 extending outwardly adjacent to the bottom end thereof to contact with a bottom end of an external sleeve 34.

To increase configuration space of the light conductor 38, an area of a bottom end of the internal sleeve 33 is diminished upwardly, such that the light conductor 38 is accommodated among a lower side of the internal sleeve 33, an outer wall of the guiding member 39 and an inner wall of the external sleeve 34.

Accordingly, the guiding member 39 of the third embodiment allows replacing the second stopping portion 366, the plurality of slits 362, the first gap 363 and the second gap 364 of the second embodiment.

In this embodiment, a circuit board 501 includes a longitudinal sheet 51 and a C-shaped ring 52 and does not pass across the internal sleeve 33, so a bottom end of the longitudinal sheet 51 is directly in connection with the C-shaped ring 52, thus eliminating the connecting sheet 54 of the first embodiment and the second embodiment. Preferably, the C-shaped ring 52 directly contacts with the outer cliff 381 of the light conductor 38 to eliminate the plural extensions 53 of the first embodiment and the second embodiment, such that a plurality of LED elements 40 are arranged on an inner wall of the C-shaped ring 52 and retain in the plural indentations 382 to illuminate the input faces 311 of the plural indentations 382. The C-shaped ring 52 has a plurality of tabs 522 extending outwardly from a bottom end thereof to fix the plurality of LED elements 40 on the plurality of tabs 522. Thereby, the C-shaped ring 5 is defined between an outer wall of the outer cliff 381 and the inner wall of the internal sleeve 34.

Accordingly, the pull-out faucet of the present invention has advantages as follows:

1. The spray head 30 has brilliant illumination as being fixed on or pulled away from the pull-out faucet 1.

2. The shower assembly 3 allows switching water supply modes and illumination.

3. The pull-out faucet 1 has illumination function by using the shower assembly 3.

4. The pull-out faucet is manufactured easily and quickly at a low cost by improving its few conventional components and providing some extra components. Preferably, the pull-out faucet has the same size and appearance as the conventional one.

5. The electric wire 60 is inserted in the tunnel 13 of the flexible pipe 10, so it is not broken easily. Preferably, the electric wire 60 is mounted in the flexible pipe 10 conveniently and securely.

6. The circuit board 50 is a flexible printed circuit which is fixed in a narrow space easily. In other words, the circuit board 50 is fixed in the spray head 30 easily.

7. The angle limiter 80 is mounted between the coupling member 70 and the spray head 30 to limit the rotation of the spray head 30 smoothly within the first angle range, such as 110 degrees. Preferably, the electric wire 60 is not damaged as rotating the spray head 30.

8. The inflow member 20 includes the second stopper 25 for inserting the electric wire 60 to prevent a leakage of the water from the inflow member 29. Likewise, the conduit member 32 has the first stopper 320 installed thereon, thus avoiding the water penetrating into the internal sleeve 33 and the external sleeve 34 from the conduit member 32 to contact the circuit board 50. Furthermore, the first stopper 320 and the second stopper 25 affix the electric wire 60 fixedly.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A pull-out faucet comprising:
a body and a shower assembly mounted on the body; the shower assembly including a flexible pipe inserted into the body, an inflow member connected with an inlet segment of the flexible pipe to flow water, a spray head coupled with an outlet segment of the flexible pipe and retracted back to an outlet of the body after being pulled outwardly, a plurality of LED elements arranged in the spray head, a circuit board electrically connected with the plurality of LED elements, and an electric wire inserted into the flexible pipe and electrically connected with the circuit board to supply power; wherein
the electric wire is inserted into the flexible pipe along a tunnel of the flexible pipe;
the spray head includes a light conductor, a conduit member above the light conductor, an internal sleeve fitted onto an outer wall of the conduit member, and an external sleeve fitted onto an outer wall of the internal sleeve;
a first stopper is disposed in the conduit member and has a first orifice to extend out of the electric wire from the outlet segment of the flexible pipe to electrically connect with the circuit board;
a second stopper is fixed on the inflow member and has a second orifice so as to insert the electric wire from the inlet segment of the flexible pipe.

2. The pull-out faucet as claimed in claim 1, wherein the first stopper is made of rubber.

3. The pull-out faucet as claimed in claim 1, wherein the second stopper is made of rubber.

4. The pull-out faucet as claimed in claim 1, wherein the conduit member has an inlet chamber formed on an upper side thereof, an outlet chamber arranged on a lower side thereof, at least one passage communicating with the inlet chamber and the outlet chamber, a piston portion defined between the inlet chamber and the outlet chamber and matingly contacting with an inner wall of the internal sleeve, a receiving chamber defined between the inlet chamber and the piston portion; the inlet chamber has a first aperture formed on an inner wall thereof to contact with the first stopper.

5. The pull-out faucet as claimed in claim 4, wherein the light conductor is a guiding member, and the guiding member has a peripheral fence and a horizontal fence coupling with the peripheral fence; the horizontal fence has a central channel passing therethrough; the peripheral fence has plural peripheral channels passing therethrough; the spray head further includes a switch device operated manually to control the water to flow out of the central channel or the plural peripheral channels of the light conductor via the conduit member.

6. The pull-out faucet as claimed in claim 5, wherein the switch device has a button pressed manually by a user and accommodated in the receiving chamber of the conduit member, a valve core mounted on the conduit member and pushed by the button to move between a first closing position and a second closing position, a resilient element fixed between a top end of the light conductor and a bottom end of the valve core to elastically abut against the valve core to move back to the first closing position; when the valve core is pushed by the resilient element to maintain at the first closing position, the water is guided to flow out of the central channel through the conduit member, and when the valve core is pushed by the button to move toward the second closing position, the water is guided to flow out of the plural peripheral channels via the conduit member.

7. The pull-out faucet as claimed in claim 6, wherein the light conductor retains with the lower side of the conduit member, and the central channel of the horizontal fence is in communication with the outlet chamber, the plural peripheral channels on the horizontal fence are located outside the outlet chamber; between the piston portion and the outlet chamber are defined a third orifice and an outer room which communicates with the third orifice and the plural peripheral channels of the light conductor, wherein the valve core of the switch device slides in the third orifice along a central axis X of the spray head; the valve core has a close washer to move with the button and pushed by the resilient element to vertically move in the outlet chamber, when the valve core moves upwardly to contact with a first sealing fringe in the outlet chamber, the water in the outlet chamber is guided to flow to the central channel of the light conductor; when the valve core moves downwardly to matingly contact with a second sealing fringe on the horizontal fence to stop the water from the central channel, the water is guided to flow out of the outer room and the plural peripheral channels.

8. The pull-out faucet as claimed in claim 5, wherein the light conductor has plural input faces for inputting the lights, a light transmission portion for transmitting the lights, and an output face for outputting the lights; the circuit board is a flexible printed circuit and includes a longitudinal sheet, a C-shaped ring joining with the longitudinal sheet, and plural extensions extending toward the central axis X of the spray head; wherein the longitudinal sheet longitudinally extends between the internal sleeve and the external sleeve; the C-shaped ring surrounds around an inner wall of the light conductor and is defined between the light conductor and the internal sleeve; each extension is located above each input face, and a bottom face of each extension electrically connects with each LED element and faces to each input face.

9. The pull-out faucet as claimed in claim 8, wherein the internal sleeve has a first receiving portion for inserting the electric wire and a second receiving portion; the circuit board further includes a connecting sheet connecting with a bottom end of the longitudinal sheet and the C-shaped ring, and the connecting sheet inserts through the second receiving portion of the internal sleeve.

10. The pull-out faucet as claimed in claim 8, wherein the peripheral fence also has plural slots defined thereon to accommodate the plural extensions of the circuit board, wherein bottom surfaces of the plural slots form the plural input faces, and a bottom end of the light conductor forms the output face, among the plural input faces and the output face forms the light transmission portion.

11. The pull-out faucet as claimed in claim 5, wherein between the horizontal fence and the peripheral fence is defined an accommodating cavity which is in communication with the central channel, and the accommodating cavity accommodates a faucet aerator.

12. The pull-out faucet as claimed in claim 10, wherein each slot of the peripheral fence of the light conductor further has a first stopping portion arranged on an upper side of an outer wall thereof and has a second stopping portion arranged on a lower side of the outer wall thereof to close the internal sleeve; the light conductor further has a circular rib extending outwardly from a lower side of an outer wall of the second stopping portion opposite to the internal sleeve and the external sleeve, such that the circular rib exposes outside.

13. The pull-out faucet as claimed in claim 1, wherein the inflow member includes a connector, a tube, a seat, a U-shaped bolt, and the second stopper; a first end of the connector is inserted into the inlet segment of the flexible pipe; and the tube is screwed with a second end of the connector and has a passageway defined therein, a holder extending outwardly from an outer wall thereof, a trench formed on the holder, and two second apertures communicating with the trench; wherein the holder is cylindrical and retains with the trench, and the holder does not remove from the trench by inserting the U-shaped bolt through the two second apertures; the second stopper retains in the holder, wherein the electric wire inserts into the tube and then extends into the conduit member of the spray head along the connector and a tunnel of the flexible pipe.

14. The pull-out faucet as claimed in claim 4, wherein the shower assembly further includes a coupling member for coupling the spray head with the outlet segment of the flexible pipe, the shower assembly further includes an angle limiter fixed between the spray head and the coupling member to limit a rotation of the spray head within a first angle range relative to the flexible pipe.

15. The pull-out faucet as claimed in claim 14, wherein the coupling member includes a first joining portion, a limiting loop, a bushing, and a second joining portion; the first joining portion has a first inner segment, an first outer segment, and an opening passing through the first inner segment and the first outer segment; the first inner segment is inserted into the outlet segment of the flexible pipe, and the first outer segment has a first spherical face formed on an outer wall thereof, the opening has a locking notch; the limiting loop retains on an outer wall of the outlet segment of the flexible pipe, such that the first inner segment of the first joining portion retains in the outlet segment of the flexible pipe; the bushing is limited between the limiting loop and an inner wall of the first joining portion adjacent to the first inner segment, and the bushing has a second spherical face formed on an inner wall thereof; the second joining portion has a second outer segment and a second inner segment; the second outer segment screws with the upper side of the conduit member of the spray head, the second inner segment is limited between the first spherical face of the first spherical face and the second spherical face of the bushing, such that the second joining portion rotates freely so that the spray head is rotated smoothly.

16. The pull-out faucet as claimed in claim 15, wherein the angle limiter includes a first limitation element inserted into the locking notch of the first joining portion, wherein the first limitation element has a first pore defined therein to insert through the electric wire from the opening; a second limitation element is fixed on the upper side of the conduit member, wherein the second limitation element has a second pore corresponding to the first pore, such that the electric wire is inserted into the inlet chamber of the conduit member from the first pore via the second pore, and the second limitation element is biased against a bottom end of the first limitation element, thus limiting a rotation of the second limitation element relative to the first imitation element within a second angle range.

17. The pull-out faucet as claimed in claim 16, wherein a top end of the first limitation element is fixed in the locking notch of the first joining portion.

18. The pull-out faucet as claimed in claim 17, wherein the locking notch is formed in a polygon shape; and a bolt head is formed in a polygon shape on the top end of the first limitation element, thus fixing the first limitation element in the locking notch.

19. The pull-out faucet as claimed in claim 16, wherein the second limitation element is positioned on the upper side of the conduit member.

20. The pull-out faucet as claimed in claim 19, wherein the inlet chamber of the conduit member has plural recesses formed on the inner wall thereof; and the second limitation element has a plurality of retainers arranged on a peripheral side thereof to retain with the plural recesses.

21. The pull-out faucet as claimed in claim 16, wherein the first limitation element has two confining blocks symmetrically formed on the bottom end thereof, and the second limitation element has two troughs symmetrically arranged thereon, such that the two confining blocks contact with and rotate in the two troughs.

22. The pull-out faucet as claimed in claim 21, wherein the first limitation element and the second limitation element rotate within 110 degrees.

23. The pull-out faucet as claimed in claim 21, wherein a contact zone of each confining block and each trough is an arcuate surface.

24. The pull-out faucet as claimed in claim 4, wherein the spray head further includes a guiding member retained with a lower side of the conduit member, and the guiding member has a peripheral fence and a horizontal fence coupling with the peripheral fence; the horizontal fence has a central channel passing therethrough; the light conductor is disposed on a peripheral side of the guiding member and has at least one input face for inputting lights, at least one light transmission portion for transmitting the lights, and at least one output face for outputting the lights.

25. The pull-out faucet as claimed in claim 24, wherein the light conductor has a circular rib and plural light columns extending upwardly from an inner wall of the circular rib, wherein each light column has an input face formed on a top end thereof, and bottom ends of the plural light columns and a bottom end of the circular rib define the at least one output face, the plural light columns form the at least one light transmission portion.

26. The pull-out faucet as claimed in claim 25, wherein the peripheral fence of the guiding member has a plurality of slits extending upwardly from a bottom end thereof to insert the plural light columns of the light conductor, and the peripheral fence has a first gap and a second gap which both communicate with the plurality of slits; the circuit board is a flexible printed circuit and includes a longitudinal sheet, a C-shaped ring joining with the longitudinal sheet, and plural extensions extending toward a central axis X of the spray head; wherein the longitudinal sheet longitudinally extends between the internal sleeve and the external sleeve; the C-shaped ring is defined between the light conductor and the internal sleeve and is fixed around the plural light columns via the first gap, and each of the plurality of LED elements on each of the plural extensions of the circuit board faces to the input face of each light column.

27. The pull-out faucet as claimed in claim 26, wherein the peripheral fence of the guiding member has a first stopping portion disposed above the first gap thereof, and the peripheral fence also has a second stopping portion defined between the first gap and the second gap of the peripheral fence, such that the first stopping portion and the second stopping portion contact with an inner wall of an internal sleeve; a top end of the circular rib of the light conductor is opposite to a bottom end of the second stopping portion, a bottom end of the internal sleeve, and a bottom end of an external sleeve, such that the circular rib exposes outside.

28. The pull-out faucet as claimed in claim 24, wherein the spray head further includes a switch device operated manually to control the water to flow out of the central channel or the plural peripheral channels of the light conductor via the conduit member.

29. The pull-out faucet as claimed in claim 28, wherein the switch device has a button pressed manually by a user and accommodated in the receiving chamber of the conduit member; a valve core mounted on the conduit member and pushed by the button to move between a first closing position and a second closing position; a resilient element fixed between a top end of the light conductor and a bottom end of the valve core to elastically abut against the valve core to move back to the first closing position; when the valve core is fixed at the first closing position, the water is guided to flow out of the central channel through the conduit member; when the valve core is fixed at the second closing position, the water is guided to flow out of the plural peripheral channels via the conduit member.

30. The pull-out faucet as claimed in claim 29, wherein the central channel of the guiding member is in communication with the outlet chamber, and the plural peripheral channels are located outside the outlet chamber; between the piston portion and the outlet chamber are defined a third orifice and an outer room which communicates with the third orifice and the plural peripheral channels of the guiding member, wherein the valve core of the switch device slides in the third orifice along a central axis X of the spray head; the valve core has a close washer to move with the button and pushed by the resilient element to vertically move in the outlet chamber, when the valve core moves upwardly toward the first closing position to contact with a first sealing fringe in the outlet chamber, the water in the outlet chamber is guided to flow to the central channel of the guiding member; when the valve core moves downwardly toward the second closing position to matingly contact with a second sealing fringe on the horizontal fence of the guiding member, the water from the central channel is stopped and is guided to flow out of the outer room and the plural peripheral channels.

31. The pull-out faucet as claimed in claim 26, wherein the internal sleeve has a first receiving portion for inserting the electric wire and a second receiving portion; the circuit board further includes a connecting sheet connecting with a bottom end of the longitudinal sheet and the C-shaped ring, and the connecting sheet inserts through the second receiving portion of the internal sleeve.

32. The pull-out faucet as claimed in claim 24, wherein between the horizontal fence and the peripheral fence of the guiding member is defined an accommodating cavity which is in communication with the central channel, and the accommodating cavity accommodates a faucet aerator.

33. The pull-out faucet as claimed in claim 24, wherein the light conductor is formed in a sleeve shape to retain with the guiding member, wherein the light conductor has an outer cliff, and the outer cliff has plural indentations arranged around a middle section thereof, wherein each indentation has an input face formed on a bottom end thereof, and the outer cliff also has an output face defined on a bottom end thereof, the outer cliff among input faces of the plural indentations and the output face forms the light transmission portion.

34. The pull-out faucet as claimed in claim 33, wherein the circuit board is a flexible printed circuit and includes a longitudinal sheet and a C-shaped ring joining with the longitudinal sheet; wherein the longitudinal sheet longitudinally extends between the internal sleeve and the external sleeve; the plurality of LED elements are arranged on an inner wall of the C-shaped ring and retain in the plural indentations to illuminate the input faces of the plural indentations.

35. The pull-out faucet as claimed in claim 33, wherein the light conductor is accommodated among a lower side of the internal sleeve, an outer wall of the guiding member and an inner wall of the external sleeve; the outer cliff of the light conductor has an annular protrusion extending outwardly adjacent to the bottom end thereof to contact with the bottom end of the external sleeve.
